(19) United States
(12) Patent Application Publication
(10) Pub. No.: US 2014/0129271 A1
(43) Pub. Date: May 8, 2014

(54) POSITION LEVEL WORK SCHEDULE

(71) Applicant: SAP AG, WALLDORF (DE)

(72) Inventors: Girish Bangalore Rangaswamy, Bangalore (IN); Alexander Goetz, Muehlhausen (DE)

(73) Assignee: SAP AG, WALLDORF (DE)

(21) Appl. No.: 13/671,221

(22) Filed: Nov. 7, 2012

(51) Int. Cl. G06Q 10/06

(52) U.S. Cl. 705/7.13

(57) ABSTRACT

A first employment position business object may be created. The first employment position business object may include attribute(s). An employee business object may be associated with the first employment position business object. The employee business object may inherit the attribute(s) in response to the association. The creation or the association may be initiated through a graphical user interface. The attribute(s) may include a work schedule. The employee business object may be disassociated from the first employment position business object. The employee business object may then be associated with a second employment position business object.

### BACKGROUND

Business software such as enterprise resource planning (ERP) software implements business processes by modeling business data as business objects (BOs) with data exchange between the BOs. The business data provided via BOs can be accessed through mechanisms such as graphical user interfaces (GUIs), forms, and analytical reports.

Work processes pertaining to an employee such as hiring, transfers, promotions, and substitutions often lead to changes to the work schedule of the employee. Modeling these processes using traditional business software, especially in jobs where many employees follow a pre-defined work schedule, often requires redundant entry of data which leads to duplication of effort and wasted time.

### BRIEF DESCRIPTION OF THE DRAWINGS

FIG. 1 illustrates employee BOs and corresponding attributes.

FIG. 2 illustrates employee BOs associated with a position BO according to an embodiment.

FIG. 3 illustrates a graphical user interface (GUI) to add/modify attributes associated with position BOs.

FIG. 4 shows an exemplary architecture in an embodiment of the invention.

### DETAILED DESCRIPTION

Embodiments may be discussed in systems to efficiently associate attributes such as work schedules with employees. In an embodiment, a first employment position business object may be created. The first employment position business object may include one or more attributes. An employee business object may be associated with the first employment position business object. The employee business object may inherit the attribute(s) in response to the association. In an embodiment, the creation or the association may be initiated through a graphical user interface.

In an embodiment, the attribute(s) may include a work schedule. In an embodiment, the employee business object may be disassociated from the first employment position business object. The employee business object may then be associated with a second employment position business object. In an embodiment, in response to a lapse of a predetermined period of time after associating the employee business object with the second employment position business object, the employee business object may be disassociated from the second employment position business object, and the employee business object may be re-associated with the first employment position business object.

Business software usually includes a standard set of BOs which can be utilized by the software user to model a business entity. For example, in an embodiment, business software may include BOs representing business entities such organizations, employees, work agreements, etc. Each BO may include or be linked to attributes which define metadata associated with the BO. For example, an organization BO may represent a police department of a particular city. The organization BO may be linked to attributes such as the name of the police department, the number of employees, the address(es) of the police department, budgets, costs of operation, revenue, and contact phone numbers. The police department may include multiple employees. Therefore, the organization BO may be linked to employee BOs which represent each employee in the police department. Each employee BO may be linked to attributes such as the name, address, work schedule, title, phone number, and salary of that particular employee.

Furthermore, business software may include processes associated with the BOs to represent events. For example, a “hiring” process may represent the event of hiring a new employee. A “transfer” process may represent the event of transferring an employee from one police department to another police department. A “promotion” process may represent the promotion of an employee from one position in the police department to a more senior position in the police department. A “substitution” process may represent a temporary substitution of a first employee with a second employee, where the second employee takes over one or more of the responsibilities of the first employee for a predefined period of time.

A process may modify one or more associated BOs in response to the occurrence of an event represented by the process. The associated BOs may be modified by adding, changing, and/or deleting attributes linked to the BOs. For example, hiring an employee may trigger the addition and/or linking of salary, work schedule, title, and/or phone number attributes to the employee BO representing the employee. Similarly, promoting an employee from a position to a more senior position may trigger a change in the salary, work schedule, title, and/or phone number attributes linked to the employee BO representing the employee.

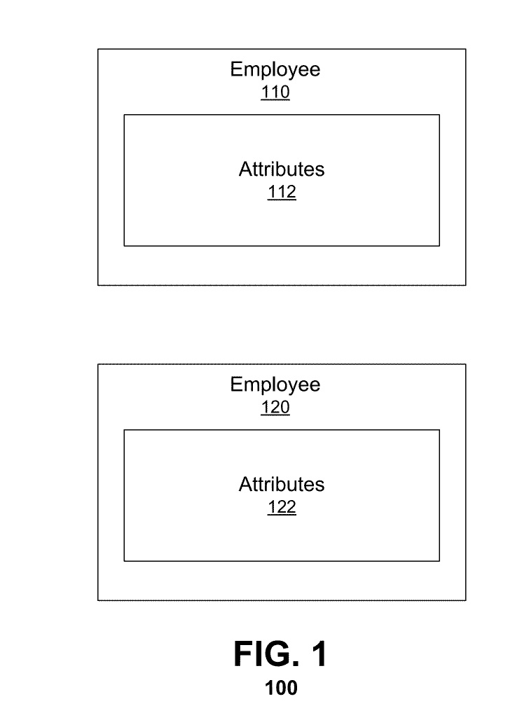

FIG. 1 illustrates employee BOs and corresponding attributes. Traditionally, when a hiring process is executed via business software, an employee BO may be created and the attributes associated with the newly created employee BO may have to be manually entered. For example, employee BO 110 may be created when an employee, employee A, is hired by an organization. A user may then manually enter the attributes 112 associated with employee BO 110 based on the salary, work schedule, title, etc., of the hired employee. In response, the business software may internally link the manually entered attributes 112 to the employee 110. If a second employee, employee B, is hired by the organization, the above steps may have to be repeated to create a corresponding employee BO 120 and associated attributes 122.

The problem with the above approach is that attributes have to be manually entered for every single hired employee. Therefore, if multiple employees have the same characteristics, a user will have to redundantly manually enter the same information multiple times. In an embodiment, “position” BOs may be utilized to efficiently execute processes associated with employee BOs.

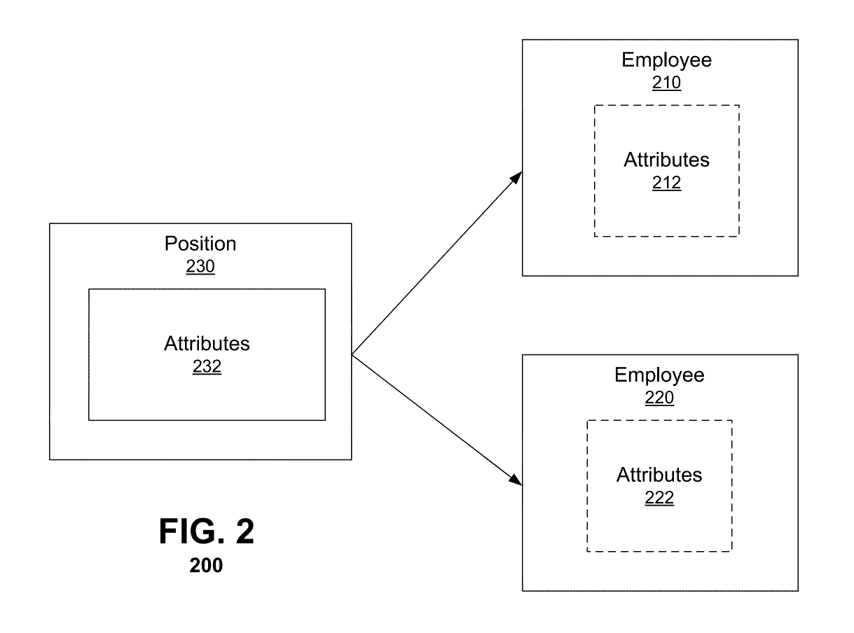

FIG. 2 illustrates employee BOs associated with a position BO according to an embodiment. A position BO 230 may be created to represent a work position such as a police officer position, detective position, or sergeant position. In an embodiment, the position BO 230 may be linked to attributes specific to the position represented by the position BO 230. For example, the position BO 230 may represent a police officer position. The police officer position BO 230 may include attributes such as a police officer's salary and/or work schedule.

In an embodiment, employees hired to a position represented by position BO 230 may be linked to position BO 230. For example, employee BO 210 may be created when an employee, employee C, is hired by an organization. Employee C may be hired as a police officer. Therefore, employee BO 210 may be linked to police officer BO 230. Consequently, employee BO 210 may also be linked to the attributes 232 associated with position 230. In other words, employee BO 210 may inherit the attributes 232 associated with position 230 when it is linked to position 230. Similarly, employee BO 220 may be created when another employee, employee D, is hired by the organization. Employee D may also be hired as a police officer. Therefore, employee BO 220 may be linked to police officer BO 230. Consequently, employee BO 220 may also be linked to the attributes 232 associated with position 230. In other words, employee BO 220 may inherit the attributes 232 associated with position 230 when it is linked to position 230.

Linking employee BOs to position BOs (and as a result, the underlying attributes of the position BOs) may be efficient because it reduces redundancy in situations where multiple employees have the same attributes. For example, in public sector organizations such as police departments, employees of the same rank (or position) often have the same work schedules and salaries. Thus, the common attributes such as work schedules and salaries only need to be entered once when creating the position BO. When employee BOs are created (during, for example, the hiring process) the employee BOs are linked to the position BO, and therefore, the work schedule and salaries don't need to be re-entered.

In an embodiment, additional attributes (212 and 222) which are specific to the employee BOs may be linked directly to employee BOs. For example, although employee C and employee D may have the same work schedule and salary (linked to the position), employees C and D may not share certain attributes such as name, personal address, office, phone number, etc. Therefore, in an embodiment, the attributes not shared by employee C (212) and employee D (222) may be directly linked to employee BOs 210 and 220, but not to position 230.

A person having ordinary skill in the art will appreciate that the granularity of position BOs may be varied based on the needs of an organization. For example, as explained above, a position BO may represent a rank in an organization such as police officer, detective, and sergeant. The position BO may be more granular. For example, a position BO may represent the position of an employee in a particular geographical location (for example, a police officer in Nebraska, a police officer in New York, etc.) and/or the position of an employee in a particular department within the organization (for example, a police officer in the drug prevention unit, a police officer in the traffic violations unit, etc.). Similarly, the position BO may be less granular. For example, a position BO may generally represent a public sector position and/or a private sector position.

In an embodiment, in response to a transfer process, an employee BO may be disassociated (unlinked) from a position BO and linked to another position BO. For example, a police officer may be transferred from a police department in Nebraska to a police department in New York. As a result, the police officer may need to follow a new work schedule, i.e., the schedule followed by the police officers in New York. To model the transfer, the employee BO representing the police officer may be unlinked from a position BO representing a police officer position in Nebraska (which includes the Nebraska work schedule), and be linked to a position BO representing a police officer position in New York (which includes the New York work schedule). This avoids the need to manually change the work schedule of the employee BO representing the police officer.

In an embodiment, in response to a promotion process, an employee BO may be disassociated (unlinked) from a position BO and linked to another position BO. For example, an employee may be promoted from a police officer rank to a detective rank. As a result, the employee may need to follow a new work schedule, i.e., the schedule followed by detectives. To model the promotion, the employee BO representing the employee may be unlinked from a position BO representing a police officer position (which includes a police officer work schedule), and be linked to a position BO representing a detective position (which includes a detective work schedule).

In an embodiment, in response to a substitution process, an employee BO may be disassociated (unlinked) from a position BO and linked to another position BO as explained above in the transfer process for a temporary period of time. For example, a police officer may take over the duties of a detective for a temporary time period. As a result, the police officer may need to follow a new work schedule, i.e., the schedule followed by detectives. To model the substitution, the employee BO representing the police officer may be unlinked from a position BO representing a police officer position (which includes a police officer work schedule), and be linked to a position BO representing a detective position (which includes a detective work schedule) temporarily. When the temporary time period elapses, the employee BO representing the police officer may be unlinked from the detective position BO, and be re-linked back to the police officer BO. In another embodiment, an employee BO may be linked to multiple position BOs to model a temporary substitution where the employee is performing tasks related to multiple positions for a temporary period of time.

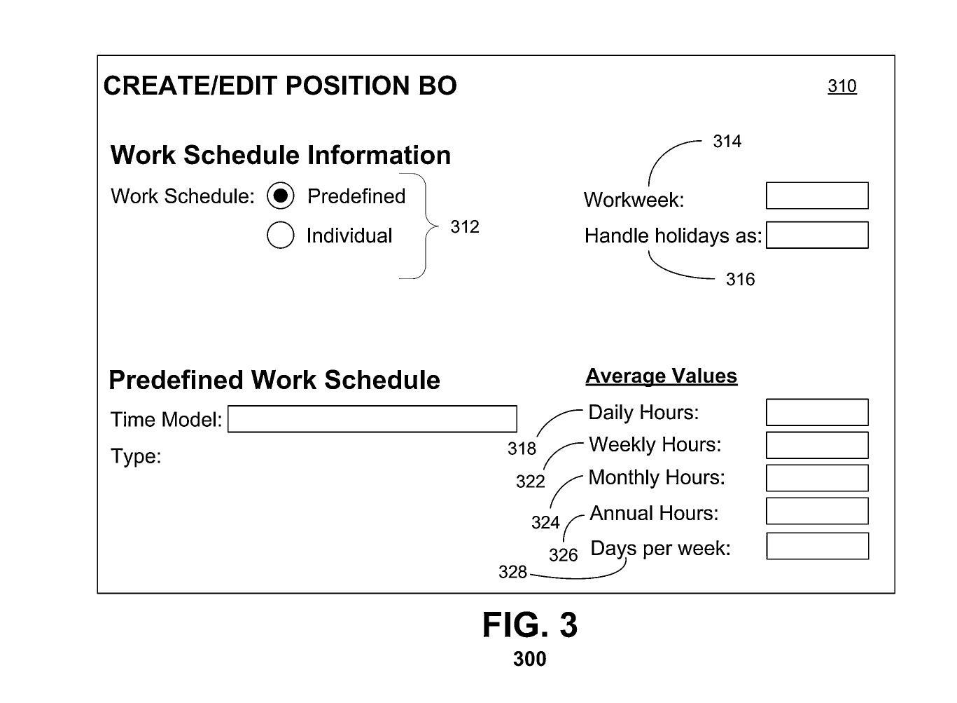

FIG. 3 illustrates a GUI 300 to add/modify attributes associated with position BOs. In an embodiment, a position BO which represents a position in an organization may be created using GUI 300. As part of the creation process, the GUI 300 may display one or more screens to assign/modify properties of the position BO. One such screen 310 may present an interface to add/modify one or more attributes associated with the position BO. For example, screen 310 may present an interface to associate a work schedule with the position BO. The screen 310 may present an option 312 to select a predefined (previously created and saved) work schedule or a newly created schedule (individual).

In an embodiment, the screen 310 may present fields for various attributes associated with the work schedule such as the days in a work week 314, the handling of holidays 316, the number of average daily work hours 318, the number of average weekly work hours 322, the number of average monthly work hours 324, the number of average annual work hours 326, and average work days per week 328. In an embodiment, in response to selecting a predefined work schedule 312 through the GUI 300, one or more of the work schedule attribute fields 314-328 may be automatically populated with the attribute values previously associated with the selected predefined work schedule. The attribute values may be retrieved from a storage device such as a database.

In another embodiment, after selecting an individual work schedule 312 through the GUI 300, a user may enter one or more values in the work schedule attribute fields 314-328. The values entered by the user may then be associated with the individual schedule and stored in a storage device such as a database.

In an embodiment, GUI 300 may present the user with one or more other screens (not shown) to enter/select more details pertaining to the newly created position BO. Once the user completes the process of creating the position BO through GUI 300, the selected predefined or individual work schedule may be associated with the newly created position BO by storing the necessary data in a storage device such as a database.

A person having ordinary skill in the art will appreciate that in other embodiments, a GUI such as GUI 300 may be utilized to edit the attributes of a previously created position BO by presenting the user with fields and options to modify attributes such as the work schedule associated with the previously created position BO. In an embodiment, a GUI (not shown) may be utilized to create/modify employee BOs. The GUI may present a user with mechanisms to link employee BOs to existing position BOs (similar to the GUI 300 features which allow the user to link position BOs to work schedules as described above).

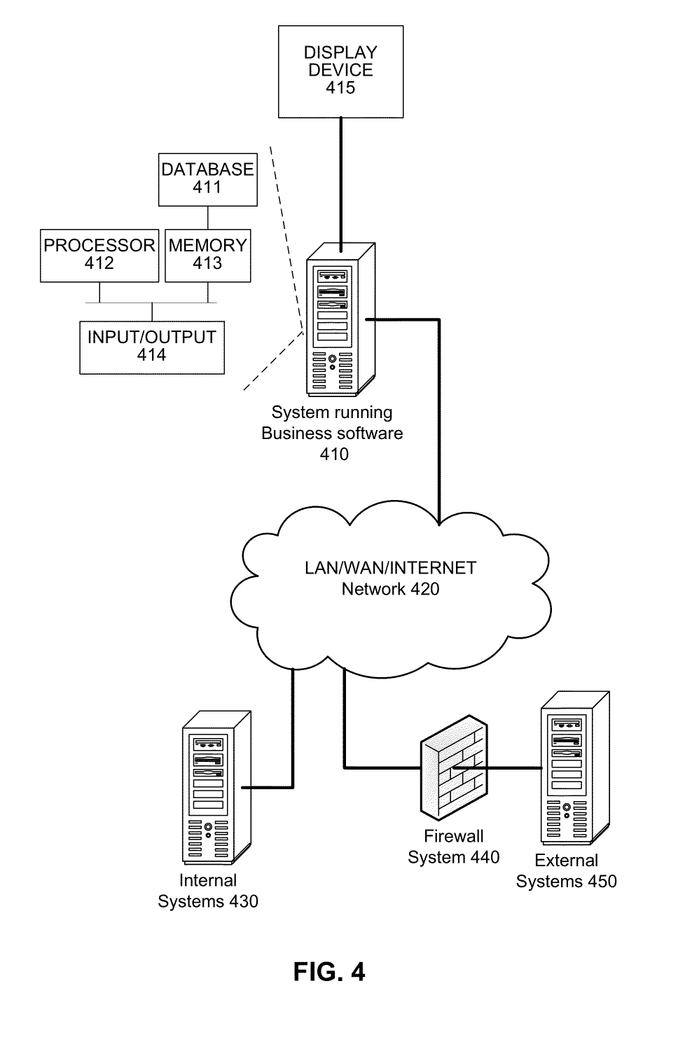

FIG. 4 shows an exemplary architecture in an embodiment of the invention. The system running an application to view, create, or modify BOs 410 may be coupled to a display device 415, existing internal systems 430 through a network 420 and to external systems 450 through the network 420 and firewall system 440. The system running an application to view, create, or modify BOs 410 may include a desktop computer, laptop computer, tablet PC, client computer, mobile phone, central computer in a vehicle, any device with a touch screen, and any other computer. The display device 415 may include a computer monitor, a touch screen, a tablet PC screen, a mobile phone screen, and any other displays. The existing internal systems 430 may include a server and may provide business data and/or other data. The external systems 450 may include a server and may be maintained by a third party, such as an information service provider, and may contain business data and/or other data, that may be updated by the third party on a periodic basis. The system running an application to view, create, or modify BOs 410 may interact with these external systems to obtain updates through a firewall system 440 separating the internal systems from the external systems.

A person having ordinary skill in the art will appreciate that while internal systems 430 and external systems 450 are included in FIG. 4, in some embodiments, one or both of these systems may not be required. In an embodiment, the functionality provided by the internal systems 430 and external systems 450 may be provided by the system running the application to view, create, or modify BOs 410.

Each of the systems in FIG. 4 may contain a processing device 412, memory 413, a database 411, and an input/output interface 414, all of which may be interconnected via a system bus. In various embodiments, each of the systems 410, 430, 440, and 450 may have an architecture with modular hardware and/or software systems that include additional and/or different systems communicating through one or more networks. The modular design may enable a business to add, exchange, and upgrade systems, including using systems from different vendors in some embodiments. Because of the highly customized nature of these systems, different embodiments may have different types, quantities, and configurations of systems depending on the environment and organizational demands.

In an embodiment, memory 413 may contain different components for retrieving, presenting, changing, and saving data. Memory 413 may include a variety of memory devices, for example, Dynamic Random Access Memory (DRAM), Static RAM (SRAM), flash memory, cache memory, and other memory devices. Additionally, for example, memory 413 and processing device(s) 412 may be distributed across several different computers that collectively comprise a system.

Database 411 may include any type of data storage adapted to searching and retrieval. The database 411 may include SAP database (SAP DB), Informix, Oracle, DB2, Sybase, and other such database systems. The database 411 may include SAP's HANA (high performance analytic appliance) in-memory computing engine and other such in-memory databases.

Processing device 412 may perform computation and control functions of a system and comprises a suitable central processing unit (CPU). Processing device 412 may comprise a single integrated circuit, such as a microprocessing device, or may comprise any suitable number of integrated circuit devices and/or circuit boards working in cooperation to accomplish the functions of a processing device. Processing device 412 may execute computer programs, such as object-oriented computer programs, within memory 413.

The foregoing description has been presented for purposes of illustration and description. It is not exhaustive and does not limit embodiments of the invention to the precise forms disclosed. Modifications and variations are possible in light of the above teachings or may be acquired from the practicing embodiments consistent with the invention. For example, some of the described embodiments may include software and hardware, but some systems and methods consistent with the present invention may be implemented in software or hardware alone. Additionally, although aspects of the present invention are described as being stored in memory, this may include other computer readable media, such as secondary storage devices, for example, solid state drives, or DVD ROM; the Internet or other propagation medium; or other forms of RAM or ROM.

We claim:

1. A computer-implemented method comprising:
creating a first employment position business object, wherein the first employment position business object includes at least one work schedule attribute; and
associating an employee business object with the first employment position business object, wherein the employee business object inherits the at least one work schedule attribute in response to the association, and at least one of the creating and the associating is initiated through a graphical user interface.

2. A computer-implemented method comprising:
creating a first employment position business object, wherein the first employment position business object includes at least one attribute; and
associating an employee business object with the first employment position business object, wherein the employee business object inherits the at least one attribute in response to the association.

3. The method of claim 2, wherein the at least one attribute includes a work schedule.

4. The method of claim 2, further comprising:
disassociating the employee business object from the first employment position business object; and
associating the employee business object with a second employment position business object.

5. The method of claim 4, further comprising:
in response to a lapse of a predetermined period of time after associating the employee business object with the second employment position business object, disassociating the employee business object from the second employment position business object; and
re-associating the employee business object with the first employment position business object.

6. The method of claim 2, wherein at least one of the creating and the associating is initiated through a graphical user interface.

7. An apparatus comprising:
a processor to:
create a first employment position business object, wherein the first employment position business object includes at least one attribute; and
associate an employee business object with the first employment position business object, wherein the employee business object inherits the at least one attribute in response to the association.

8. The apparatus of claim 7, wherein the at least one attribute includes a work schedule.

9. The apparatus of claim 7, wherein the processor is further configured to:
disassociate the employee business object from the first employment position business object; and
associate the employee business object with a second employment position business object.

10. The apparatus of claim 9, wherein the processor is further configured to:
in response to a lapse of a predetermined period of time after associating the employee business object with the second employment position business object, disassociate the employee business object from the second employment position business object; and
re-associate the employee business object with the first employment position business object.

11. The apparatus of claim 7, further comprising:
a display to display a graphical user interface to initiate the creation and the association.

12. A non-transitory computer-readable medium embodied with computer-executable instructions for causing a computer to execute instructions, the computer instructions comprising:
creating a first employment position business object, wherein the first employment position business object includes at least one attribute; and
associating an employee business object with the first employment position business object, wherein the employee business object inherits the at least one attribute in response to the association.

13. The computer-readable medium of claim 12, wherein the at least one attribute includes a work schedule.

14. The computer-readable medium of claim 12, wherein the computer instructions further comprise:
disassociating the employee business object from the first employment position business object; and
associating the employee business object with a second employment position business object.

15. The computer-readable medium of claim 14, wherein the computer instructions further comprise:
in response to a lapse of a predetermined period of time after associating the employee business object with the second employment position business object, disassociating the employee business object from the second employment position business object; and
re-associating the employee business object with the first employment position business object.

16. The computer-readable medium of claim 12, wherein at least one of the creating and the associating is initiated through a graphical user interface.
